(19) United States
(12) Patent Application Publication
(10) Pub. No.: US 2016/0112924 A1
(43) Pub. Date: Apr. 21, 2016

(54) EARLY RADIO LINK FAILURE (RLF) DECLARATION

(71) Applicant: QUALCOMM Incorporated, San Diego, CA (US)

(72) Inventors: Chintan Pravin Turakhia, San Diego, CA (US); Vidyadhar Adiraju, San Diego, CA (US); Amir Aminzadeh Gohari, Sunnyvale, CA (US); Neelakanta Venkata Seshachalam Chimmapudi, San Diego, CA (US); Srinivasan Balasubramanian, San Diego, CA (US); Aziz Gholmieh, Del Mar, CA (US); Masato Kitazoe, Tokyo (JP)

(21) Appl. No.: 14/883,351

(22) Filed: Oct. 14, 2015

Related U.S. Application Data
(60) Provisional application No. 62/064,039, filed on Oct. 15, 2014.

(51) Int. Cl. H04W 36/30; H04W 24/10

(52) U.S. Cl. CPC H04W 36/30; H04W 24/10

(57) ABSTRACT

Methods, systems, and devices are described for early radio link failure (RLF) declaration. A UE may identify a measurement report message (MRM) trigger and initiate an RLF procedure. In the RLF procedure the UE may determine whether a radio link condition indicative of an RLF has been satisfied before an expiration of a timer that is initiated by the MRM trigger. As an example, the UE may determine that a threshold number of uplink radio link signaling messages, such as MRMs, have been transmitted without a radio link control (RLC) acknowledgement (ACK). The UE may declare RLF based on the determination that the radio link condition has been satisfied. In some examples the UE may verify that channel conditions are better for a target cell than for the serving cell, and may declare RLF based further on the channel comparison.

### CROSS REFERENCES

The present application for patent claims priority to U.S. Provisional Patent Application No. 62/064,039 by Turakhia et al., entitled “Early Radio Link Failure (RLF) Declaration,” filed Oct. 15, 2014, assigned to the assignee hereof, and expressly incorporated by reference herein in its entirety.

### BACKGROUND

1. Field of Disclosure

The present disclosure, for example, relates to wireless communication and more specifically to techniques for early radio link failure (RLF) declaration.

2. Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., a Long Term Evolution (LTE) system).

By way of example, a wireless multiple-access communications system may include a number of base stations, each simultaneously supporting communication for multiple communication devices, which may be otherwise known as user equipment (UE). A base station may communicate with UEs on downlink channels (e.g., for transmissions from a base station to a UE) and uplink channels (e.g., for transmissions from a UE to a base station).

In some cases, a radio link between a UE and a base station deteriorates to the point that effective communications are terminated. In this case, the base station may drop context information for the UE, and the UE may perform an RLF procedure. The RLF procedure may involve establishing a new radio connection with a different base station. The new base station may attempt to obtain the context information from the previous serving station. But if the previous base station has dropped the context information, this request may fail and a delay may be incurred while the new base station and the UE reestablish a new context.

### SUMMARY

Systems, methods, and apparatuses for early radio link failure (RLF) declaration are described. A UE may determine that RLF is imminent by identifying a measurement reporting trigger, transmitting a measurement report message (MRM), and then detecting a radio link condition indicative of an RLF. For example, the UE may determine that no radio link control (RLC) acknowledgement (ACK) has been received for a threshold number of uplink (UL) messages, which may include the MRM, or the UE may determine a number of unsuccessful RLC layer retransmissions have occurred after the measurement reporting trigger. The UE may then initiate an RLF procedure based on detecting the condition indicative of RLF. In some examples the UE may additionally verify that channel conditions are better for a target cell than for the serving cell and establish a connection to the target cell after initiating the RLF procedure.

A method of wireless communication at a UE is described. The method may include: identifying a measurement reporting trigger; transmitting a measurement report message (MRM) in response to identifying the measurement reporting trigger; detecting a condition indicative of a radio link failure (RLF) based at least in part on a number of uplink (UL) messages transmitted without radio link control (RLC) layer acknowledgement (ACK), the number of UL messages including the transmitted MRM, or a number of unsuccessful RLC layer retransmissions after the measurement reporting trigger; and initiating an RLF procedure of the UE based at least in part on detecting the condition indicative of a RLF.

An apparatus for wireless communication at a UE is described. The apparatus may include: means for identifying a measurement reporting trigger; means for transmitting a measurement report message (MRM) in response to identifying the measurement reporting trigger; means for detecting a condition indicative of a radio link failure (RLF) based at least in part on a number of uplink (UL) messages transmitted without radio link control (RLC) layer acknowledgement (ACK), the number of UL messages including the transmitted MRM, or a number of unsuccessful RLC layer retransmissions after the measurement reporting trigger; and means for initiating an RLF procedure of the UE based at least in part on detecting the condition indicative of a RLF.

Another apparatus for wireless communication at a UE is described. The apparatus may include a processor, memory in electronic communication with the processor, and instructions stored in the memory. The code may be operable, when executed by the processor, to cause the apparatus to: identify a measurement reporting trigger; transmit a measurement report message (MRM) in response to identifying the measurement reporting trigger; detect a condition indicative of a radio link failure (RLF) based at least in part on a number of uplink (UL) messages transmitted without radio link control (RLC) layer acknowledgement (ACK), the number of UL messages including the transmitted MRM, or a number of unsuccessful RLC layer retransmissions after the measurement reporting trigger; and initiate an RLF procedure of the UE based at least in part on detecting the condition indicative of a RLF.

A non-transitory computer-readable medium storing code for wireless communication at a UE is described. The code may include instructions executable to: identify a measurement reporting trigger; transmit a measurement report message (MRM) in response to identifying the measurement reporting trigger; detect a condition indicative of a radio link failure (RLF) based at least in part on a number of uplink (UL) messages transmitted without radio link control (RLC) layer acknowledgement (ACK), the number of UL messages including the transmitted MRM, or a number of unsuccessful RLC layer retransmissions after the measurement reporting trigger; and initiate an RLF procedure of the UE based at least in part on detecting the condition indicative of a RLF.

Some examples of the method, apparatuses, or non-transitory computer-readable medium may include steps, features, means, or instructions for: measuring a value corresponding to a serving cell channel parameter; measuring a value corresponding to a target cell channel parameter; verifying that a channel comparison condition has been satisfied based at least in part on the value corresponding to the serving cell channel parameter and the value corresponding to the target cell channel parameter; and initiating the RLF procedure based at least in part on a result of verifying that the channel comparison condition has been satisfied.

In some examples of the method, apparatuses, or non-transitory computer-readable medium, verifying that the channel comparison condition has been satisfied may include processes, features, means, or instructions for determining that the serving cell channel parameter is below a first threshold and determining that the target cell channel parameter is above a second threshold. In some examples of the method, apparatuses, or non-transitory computer-readable medium, verifying that the channel comparison condition has been satisfied may include processes, features, means, or instructions for determining that the target cell channel parameter exceeds the serving cell channel parameter by at least an offset value.

In some examples of the method, apparatuses, or non-transitory computer-readable medium, the serving cell channel parameter may include a reference signal received quality (RSRQ) parameter or a radio link monitoring signal to noise ratio (RLM SNR). In some examples of the method, apparatuses, or non-transitory computer-readable medium, the target cell channel parameter may include a reference signal received quality (RSRQ) parameter or a radio link monitoring signal to noise ratio (RLM SNR).

Some examples of the method, apparatuses, or non-transitory computer-readable medium may include steps, features, means, or instructions for: establishing a connection to a target cell after initiating the RLF procedure of the UE.

In some examples of the method, apparatuses, or non-transitory computer-readable medium, the measurement reporting trigger may be an A1, A2, A3, A4, A5, B1, or B2 event in a measurement configuration of the UE.

In some examples of the method, apparatuses, or non-transitory computer-readable medium, the steps, features, means, or instructions for detecting a condition indicative of a RLF may be operable based at least in part on a traffic type indication. In some examples of the method, apparatuses, or non-transitory computer-readable medium, the steps, features, means, or instructions for detecting a condition indicative of a RLF may be operable based at least in part on a physical (PHY) layer block error rate (BLER), a medium access control (MAC) BLER or a RLC error rate.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 illustrates an example of a wireless communications system in accordance with aspects of the present disclosure;

FIG. 2 illustrates an example of a wireless communications subsystem for early RLF declaration in accordance with aspects of the present disclosure;

FIG. 3A illustrates an example of a channel comparison condition for early RLF declaration in accordance with aspects of the present disclosure;

FIG. 3B illustrates an example of a channel comparison condition for early RLF declaration in accordance with aspects of the present disclosure;

FIG. 4 illustrates an example of a decision flow for early RLF declaration in accordance with aspects of the present disclosure;

FIG. 5 shows a block diagram of a user equipment (UE) that supports early RLF declaration in accordance with aspects of the present disclosure;

FIG. 6 shows a block diagram of a UE that supports early RLF declaration in accordance with aspects of the present disclosure;

FIG. 7 shows a block diagram of an early RLF module that supports early RLF declaration in accordance with aspects of the present disclosure;

FIG. 8 illustrates a block diagram of a system including a UE that supports early RLF declaration in accordance with aspects of the present disclosure;

FIG. 9 shows a flowchart illustrating a method for early RLF declaration in accordance with aspects of the present disclosure;

FIG. 10 shows a flowchart illustrating a method for early RLF declaration in accordance with aspects of the present disclosure;

FIG. 11 shows a flowchart illustrating a method for early RLF declaration in accordance with aspects of the present disclosure;

FIG. 12 shows a flowchart illustrating a method for early RLF declaration in accordance with aspects of the present disclosure; and

FIG. 13 shows a flowchart illustrating a method for early RLF declaration in accordance with aspects of the present disclosure.

### DETAILED DESCRIPTION

A UE may determine that RLF is imminent by identifying a measurement reporting trigger, transmitting a measurement report message (MRM), and then detecting a radio link condition indicative of an RLF. For example, the UE may determine that no radio link control (RLC) acknowledgement (ACK) has been received for a threshold number of uplink (UL) messages, which may include the MRM, or the UE may determine a number of unsuccessful RLC layer retransmissions have occurred after the measurement reporting trigger. The UE may than initiate an RLF procedure based on detecting the condition indicative of RLF. In some examples the UE may additionally verify that channel conditions are better for a target cell than for the serving cell and establish a connection to the target cell after initiating the RLF procedure.

Thus, according to the present disclosure, a UE may make an early RLF determination based on conditions indicative of an impending RLF without waiting for channel conditions to completely deteriorate, for expiration of a fixed timer, etc. Advantageously, according to the present disclosure, if radio link conditions between a UE and a base station are deemed likely to result in RLF, the UE may establish a connection with a target cell before the serving cell drops the context information. This may mitigate the delay associated with the RLF and connection re-establishment procedure, and may thus reduce the likelihood of a service disruption for the user.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

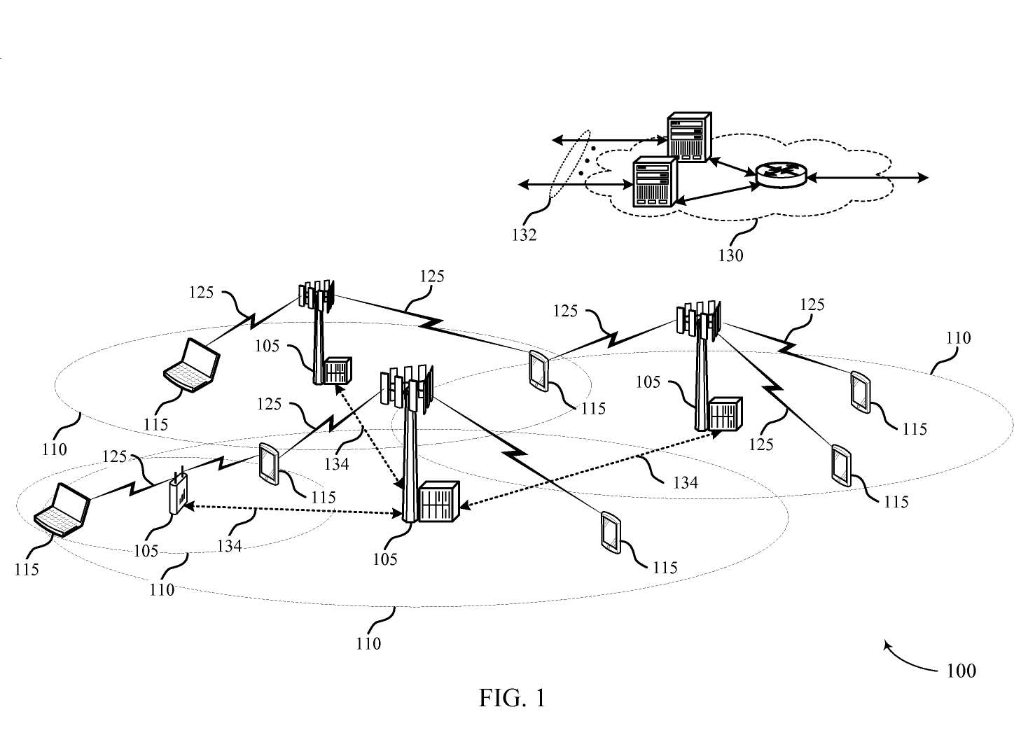

FIG. 1 illustrates an example of a wireless communications system 100 in accordance with aspects of the present disclosure. The wireless communications system 100 includes base stations 105, at least one UE 115, and a core network 130. The core network 130 may provide user authentication, access authorization, tracking, internet protocol (IP) connectivity, and other access, routing, or mobility functions. The base stations 105 interface with the core network 130 through backhaul links 132 (e.g., S1, etc.). The base stations 105 may perform radio configuration and scheduling for communication with the UEs 115, or may operate under the control of a base station controller (not shown). In various examples, the base stations 105 may communicate, either directly or indirectly (e.g., through core network 130), with each other over backhaul links 134 (e.g., X1, etc.), which may be wired or wireless communication links.

The base stations 105 may wirelessly communicate with the UEs 115 via one or more base station antennas. Each of the base stations 105 may provide communication coverage for a respective geographic coverage area 110. In some examples, base stations 105 may be referred to as a base transceiver station, a radio base station, an access point, a radio transceiver, a NodeB, eNodeB (eNB), Home NodeB, a Home eNodeB, or some other suitable terminology. The geographic coverage area 110 for a base station 105 may be divided into sectors making up only a portion of the coverage area (not shown). The wireless communications system 100 may include base stations 105 of different types (e.g., macro and small cell base stations). The base stations 105 may be configured to communicate with one or more communication technologies, where each communication technology may have an associated geographic coverage area 110. The geographic coverage area 110 for a first communication technology may overlap with the geographic coverage area 110 for a second communication technology, and the first and second communication technology may be associated with the same base station 105, or different base stations 105. Additionally or alternatively, wireless communications system 100 may support synchronous or asynchronous operation. The techniques described herein may be used for either synchronous or asynchronous operations.

In some examples, the wireless communications system 100 is a Long Term Evolution (LTE)/LTE-Advanced (LTE-A) network. In LTE/LTE-A networks, the term evolved node B (eNB) may be used to describe the base stations 105. The wireless communications system 100 may be a heterogeneous LTE/LTE-A network in which different types of eNBs provide coverage for various geographical regions. For example, each eNB or base station 105 may provide communication coverage for a macro cell, a small cell, or other types of cell. The term “cell” is a 3GPP term that can be used to describe a base station, a carrier, or component carrier associated with a base station, or a coverage area (e.g., sector, etc.) of a carrier or base station, depending on context.

A macro cell covers a relatively large geographic area (e.g., several kilometers in radius) and may allow unrestricted access by UEs 115 with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs 115 with service subscriptions with the network provider. A femto cell may also cover a small geographic area (e.g., a home) and may provide restricted access by UEs 115 having an association with the femto cell (e.g., UEs 115 in a closed subscriber group (CSG), UEs 115 for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers).

In some cases, a network may include small cells whose geographic coverage areas 110 may overlap the geographic coverage area 110 of one or more macro base stations 105. For example, small cells may be added in areas with high user demand or in areas not sufficiently covered by a macro base station 105. For example, a small cell may be located in a shopping center, or in an area where signal transmissions are blocked by terrain or buildings. In some cases, small cells may improve network performance by allowing macro base stations 105 to offload traffic when load is high. A network that includes both large and small cells may be known as a heterogeneous network. A heterogeneous network may also include Home eNBs (HeNBs) which may provide service a restricted group known as a closed subscriber group (CSG). For example, an office building may contain small cells for use only by the occupants of the building. In some cases, heterogeneous networks may involve more complex network planning and interference mitigation techniques than homogenous networks.

In some examples, cell density may impact frequency of RLF. For instance, RLFs may occur more frequently in areas with fast-fading cell conditions. Such areas may include dense or hyper-dense urban deployments of small cells or heterogeneous networks (e.g., Manhattan, downtown Los Angeles, etc.). In some examples, small cell to macro cell mobility (e.g., at a cell edge) may result in a fast fading condition and RLF. Six-sector cell deployments and macro cell to in-building (e.g., into a building-located small) coverage may likewise result in RLF.

The UEs 115 may be dispersed throughout the wireless communications system 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with various types of base stations and network equipment including macro eNBs, small cell eNBs, relay base stations, and the like.

The communication links 125 shown in wireless communications system 100 may include uplink (UL) transmissions from a UE 115 to a base station 105, or downlink (DL) transmissions, from a base station 105 to a UE 115. The downlink transmissions may also be called forward link transmissions while the uplink transmissions may also be called reverse link transmissions. Each communication link 125 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. The communication links 125 may transmit bidirectional communications using frequency division duplex (FDD) (e.g., using paired spectrum resources) or time division duplex (TDD) operation (e.g., using unpaired spectrum resources). Frame structures may be defined for FDD (e.g., frame structure type 1) and TDD (e.g., frame structure type 2).

Wireless communications system 100 may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” “cell,” and “channel” may be used interchangeably herein. A UE 115 may be configured with multiple downlink CCs and one or more uplink CCs for carrier aggregation. Carrier aggregation may be used with both FDD and TDD component carriers.

In some examples of the wireless communications system 100, base stations 105 or UEs 115 may include multiple antennas for employing antenna diversity schemes to improve communication quality and reliability between base stations 105 and UEs 115. Additionally or alternatively, base stations 105 or UEs 115 may employ multiple input multiple output (MIMO) techniques that may take advantage of multi-path environments to transmit multiple spatial layers carrying the same or different coded data.

In some cases, LTE networks may be designed for transfer of data packets, and may use a circuit switched fall back for voice communications. But an LTE network may also be used for voice communications using a packet based system similar to voice over internet protocol (VoIP) applications such as Skype. This may be accomplished using VoLTE technology. There may be various differences between VoLTE and VoIP. For example, VoLTE service may include an explicit QoS target. To achieve the QoS threshold in poor radio conditions, VoLTE packets may utilize IP multimedia subsystem (IMS) and other network features to ensure low latency and improved error correction.

The communication networks that may accommodate some of the various disclosed examples may be packet-based networks that operate according to a layered protocol stack. For example, in the user plane communications may be based on the internet protocol (IP) packet (e.g., at the packet data convergence protocol (PDCP) layer). A radio link control (RLC) layer may perform packet segmentation and reassembly to communicate over logical channels. A medium access control (MAC) layer may perform priority handling and multiplexing of logical channels into transport channels. The MAC layer may also use hybrid automatic repeat request (HARD) to provide retransmission at the MAC layer to improve link efficiency. In the control plane, the radio resource control (RRC) protocol layer may provide establishment, configuration, and maintenance of an RRC connection between a UE 115 and the base stations 105. The RRC protocol layer may also be used for core network 130 support of radio bearers for the user plane data. At the physical (PHY) layer, the transport channels may be mapped to physical channels.

The wireless communications system 100 may include an RLC layer that connects higher layers (e.g., RRC and PDCP) to the lower layers (e.g., the MAC layer). An RLC entity in a base station 105 or a UE 115 may ensure that transmission packets are organized into appropriately sized blocks (e.g., corresponding to the MAC layer transport block size). If an incoming data packet (i.e., a PDCP or RRC service data unit (SDU)) is too big for transmission, the RLC layer may segment it into several smaller RLC protocol data units (PDUs). If the incoming packets are too small, the RLC layer may concatenate several of them into a single, larger RLC PDU. Each RLC PDU may include a header including information about how to reassemble the data. The RLC layer may also ensure that packets are reliably transmitted. The transmitter may keep a buffer of indexed RLC PDUs, and continue retransmission of each PDU until it receives the corresponding ACK. In some cases, the transmitter may send a Poll Request to determine which PDUs have been received and the receiver may respond with a Status Report. Unlike the MAC layer HARQ, RLC automatic repeat request (ARQ) may not include a forward error correction function.

An RLC entity may operate in one of three modes. In acknowledged mode (AM), unacknowledged mode (UM) and transparent mode (TM). In AM, the RLC entity may perform segmentation/concatenation and ARQ. This mode may be appropriate for delay tolerant or error sensitive transmissions. In UM, the RLC entity may perform segmentation/concatenation but not ARQ. This may be appropriate for delay sensitive or error tolerant traffic (e.g., voice over Long Term Evolution (VoLTE)). TM only includes data buffering, and does not include either concatenation/segmentation or ARQ. TM may be used primarily for sending broadcast control information (e.g., the master information block (MIB) and SIBs), paging messages, and RRC connection messages. Some transmissions may be sent without RLC (e.g., a random access channel (RACH) preamble and response).

Systems having poorly designed layer management schemes may be prone to frequent RLF events. Such networks may have issues with inter- or intra-cell mobility, multicarrier deployments, or frame-type boundaries (e.g., TDD/FDD boundaries). In some cases, a UE 115 may determine that a radio link has failed and initiate an RLF procedure. For example, an RLF procedure may be triggered upon an RLC indication that a maximum number of retransmissions has been reached, upon receiving a maximum number of out-of-sync indications, or upon radio failure during a RACH procedure. In some cases (e.g., after reaching the limit for out-of-sync indications) a UE 115 may initiate a timer and wait to determine whether a threshold number of in-sync indications are received. If the number of in-sync indications exceeds the threshold before an expiration of the RLF timer, the UE 115 may abort the RLF procedure. Otherwise, the UE 115 may perform a RACH procedure to regain access to network. The RACH procedure may include transmitting an RRC connection re-establishment request including the C-RNTI, the cell identification (ID), security verification information, and a cause for re-establishment. The base station 105 receiving the request may respond with either an RRC connection re-establishment message or an RRC connection re-establishment rejection. The RRC connection re-establishment message may contain parameters for establishing a signaling radio bearer (SRB) for the UE 115 as well as information for generating a security key. Once the UE 115 receives the RRC connection establishment message it may implement the new SRB configuration and transmit an RRC connection re-establishment complete message to the base station 105.

In some cases, a UE 115 may be transferred from a serving base station 105 (known as the source base station) to another base station 105 (known as the target base station). For example, the UE 115 may be moving into the coverage area of the target base station 105, or the target base station 105 may be capable of providing better service for the UE 115 or relieving the source base station 105 of excess load. The transition may be referred to as a “handover.” Before a handover, the source base station 105 may configure the UE 115 with procedures for measuring the signal quality of neighboring base stations 105. The UE 115 may then respond with a measurement report. The source base station 105 may use the measurement report to make the handover decision. Additionally or alternatively, the decision may be based on radio resource management (RRM) factors such as network load and interference mitigation. When the handover decision is made, the source base station 105 may send a handover request message to the target base station 105, which may include context information to prepare the target base station 105 to serve the UE 115. The target base station 105 may make an admission control decision, for example, to ensure that it can meet the quality of service (QoS) standards of the UE 115. The target base station 105 may then configure resources for the incoming UE 115, and send a handover request acknowledge message to the source base station 105, which may include RRC information to be passed on to the UE 115. The source base station 105 may then direct the UE 115 to perform the handover, and pass a status transfer message to the target base station with PDCP bearer status information. The UE 115 may attach to the target base station via a RACH procedure.

By way of example, with LTE systems, the present techniques enable early detection of RLF by, for example, monitoring radio link conditions which are associated with a high probability of RLF and in some examples corroborating the detection of such conditions with reference to source and target channel parameters. A UE 115 may determine that a RLF is imminent by identifying a measurement report message (MRM) trigger, transmitting a MRM, and then detecting that a condition indicative of an RLF has been satisfied.

For example, the UE 115 may determine that no RLC layer ACK has been received for a threshold number of UL messages, which may include the transmitted MRM. In some examples, the UE 115 may determine that a threshold number of UL messages, such as MRMs or other UL radio link signaling messages, have been transmitted without an RLC layer ACK from the source base station. In some examples, a radio link condition that indicates or suggests an RLF may include a number of unsuccessful RLC layer retransmissions exceeding a threshold, a lack of UL grants, a scheduling request exhaustion, an N310 parameter, or some combination of these conditions. Based on one or more radio link conditions indicative of an RLF, UE 115 may then initiate an RLF procedure based on detecting the condition indicative of RLF, where the RLF procedure may include declaring an RLF. This may be done independently of other RLF mechanisms such as timers, etc. in order to avoid degrading the user experience by waiting when it can determined that RLF is likely to occur. In the case of mobility, initiating the RLF procedure without delay increases the likelihood that context information for the UE will be available at the source base station. In some examples the UE may additionally establish a connection to the target cell after initiating the RLF procedure. In some examples the UE 115-a may additionally verify a channel comparison condition, such as conditions being better for a target cell than for the serving cell and base the initiation of the RLF procedure at least in part on the channel condition comparison being satisfied, and a decision to initiate the RLF procedure may be based on or made with reference to the channel comparison.

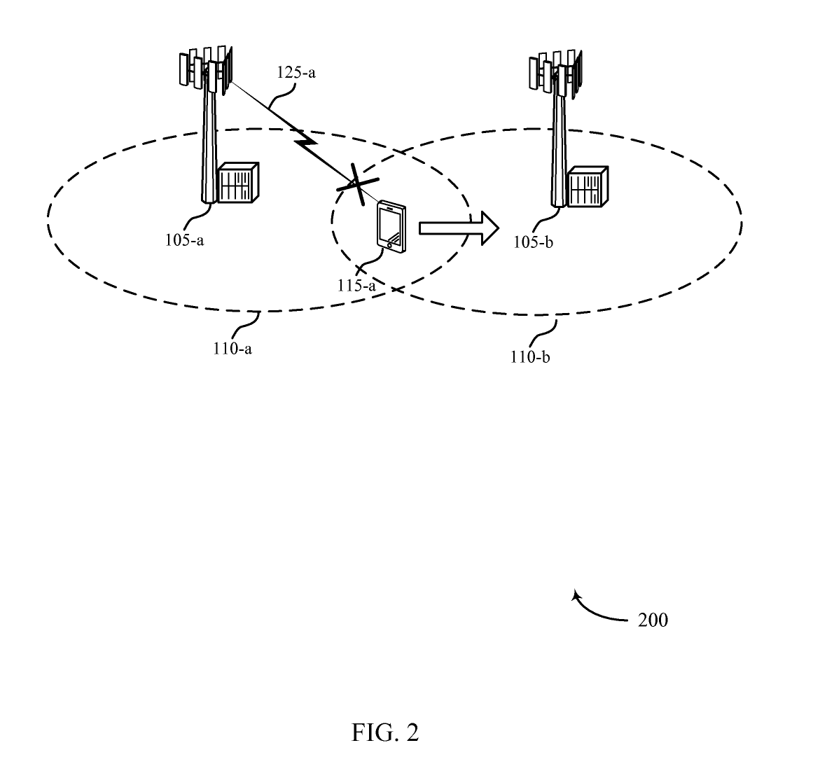

FIG. 2 illustrates an example of a wireless communications subsystem 200 for early RLF declaration in accordance with aspects of the present disclosure. Wireless communications subsystem 200 may include a UE 115-a, which may be an example of a UE 115 described with reference to FIG. 1. Wireless communications subsystem 200 may include base stations 105-a and 105-b, which may be examples of a base station 105 described with reference to FIG. 1. Base stations 105-a and 105-b may have overlapping geographic coverage areas 110-a and 110-b. UE 115-a may communicate with base stations 105-a and 105-b via communication links 125 such as described above. For example, in wireless communications subsystem 200, UE 115-a may be in communication with base station 105-a via communication link 125-a. The base stations 105-a and 105-b may be cells of a heterogeneous network, as described above.

In some cases, UE 115-a communication link 125-a may deteriorate to the point that UE 115-a may determine that RLF is imminent. UEs 115 may declare RLF by initiating an RLF procedure for a variety of reasons, and the RLF procedure may by triggered after a first MRM is sent. For instance, RLF may be declared due to high DL BLER (e.g., upon expiration of t310 or t312 timers). Or, RLF may be declared due to a lack of UL grants, a condition referred to as scheduling request (SR) exhaustion. Those skilled in the art will recognize that SR exhaustion may be based on, or derived from, dsr-Transmax and sr-ConfigIndex parameters conveyed in RRC signaling. In some cases, overhead message decode failures, such as a failure to decode a MIB or SIBs may be the cause. Or, as discussed above, a predetermined number of unsuccessful RLC layer retransmissions or a handover failure may be the cause.

Other mechanisms may contribute to RLF declarations. For instance, base stations 105 may have UE 115 failure detection mechanisms, and they may release UE context without first informing a UE 115. This may lead to UE 115 being “stuck” on a serving cell until RLF eventually occurs.

Some mobility situations may give rise to one or more of these conditions. For example, UE 115-a may be moving away from base station 105-a. The distance between UE 115-a and base station 105-a may increase to a point that communication quality suffers. Additional factors may decrease the radio link quality, such as increased interference or physical barriers between UE 115-a and base station 105-a. Or, in some cases, vendor or operator preferences can delay RLF onset conditions to the detriment of efficient UE operation. This may, however, be avoided by allowing UEs 115 to pre-emptively declare RLF, as described herein.

According to the present disclosure, UE 115-a may detect conditions indicative of imminent RLF and initiate early RLF procedures without waiting for expiration of system timers, etc. For example, when it is determined that RLF is imminent, UE 115-a may initiate an early RLF procedure in order to establish a communication link with a neighboring base station, (e.g., base station 105-b). In some cases, base station 105-b may attempt to procure context information for UE 115-a from base station 105-a in order to establish the link with UE 115-a. As a result of the early RLF declaration, base station 105-b may be able to obtain the context information for UE 115-a before base station 105-a drops the information and avoid the delay associated with reestablishing a context at base station 105-b.

Thus, according to the present disclosure, UE 115-a may identify a measurement reporting trigger, such as an MRM trigger, and monitor for indications of early RLF (e.g., by initiating an early RLF timer, monitoring for radio link signaling messages being transmitted without RLC layer ACK, monitoring for a number of unsuccessful RLC layer retransmissions, etc.). UE 115-a may then detect a condition of communication link 125-a indicative of a RLF, such as an indication that RLF is imminent. For example, UE 115-a may determine that no RLC layer ACK has been received for one or more UL messages, such as a MRM or other UL radio link signaling message, and that a predetermined time has elapsed (e.g., determine that the early RLF timer has expired) without receiving a handover command. As another example, UE 115-a may determine that a threshold number of UL messages, such as a threshold number of MRMs and/or other UL radio link signaling messages, have been transmitted without an RLC layer ACK. UE 115-a may then initiate an RLF procedure based on the detected radio link condition, which may include declaring RLF. In some examples the UE 115-a may establish a connection to the target cell initiating the RLF procedure. In some examples the UE 115-a may verify a channel comparison condition, such as conditions being better for a target cell than for the serving cell and base the declaration of RLF on the channel condition comparison being satisfied.

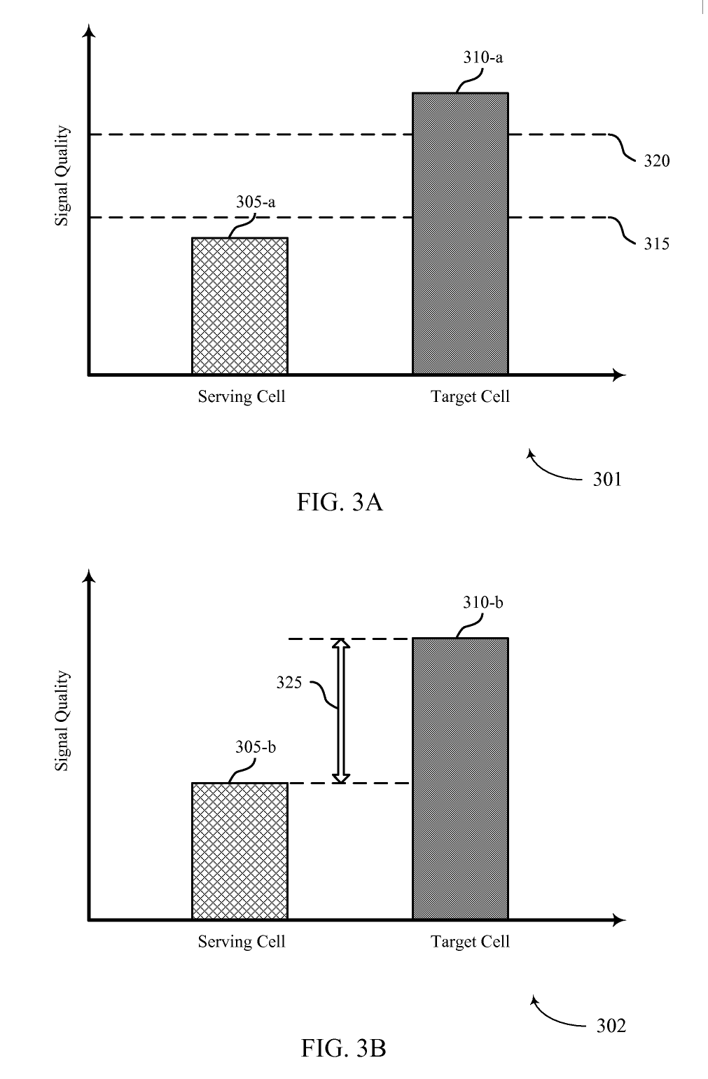

FIG. 3A illustrates an example of a channel comparison condition 301 for early RLF declaration in accordance with aspects of the present disclosure. Channel comparison condition 301 may represent a logical value or a determination of a comparison between a serving cell channel parameter 305-a and a target cell channel parameter 310-a. A channel parameter may be, or relate to a physical condition such as a signal quality, an interference level, or the like. A UE may take measurements corresponding to a physical channel condition, such as measuring a value corresponding to the serving cell channel parameter 305-a and measuring a value corresponding to the target cell channel parameter 310-a. These values may be compared directly to one another, compared directly to one or more thresholds, or otherwise support a calculation of serving cell channel parameter 305-a and target cell channel parameter 310-a as used in the channel comparison condition 301. For example, the measured value corresponding to the serving cell channel parameter 305-a and the measured value corresponding to the target cell channel parameter 310-a may be used to perform a comparison with respect to at least one of a reference signal received power (RSRP), reference signal received quality (RSRQ), a radio link monitoring signal to noise ratio (RLM SNR), or some combination of these. The channel comparison condition can be used to ensure a destination for the UE in mobility such that triggering the RLF procedure can be based both on an indication of imminent RLF and a determination that a suitable destination cell has been identified.

Channel comparison condition 301 may be satisfied if the serving cell channel parameter 305-a is below a lower threshold 315, and the target cell channel parameter 310-a is above an upper threshold 320. This, for example, may ensure that the serving cell is not capable of providing satisfactory service and that the target cell is capable of providing satisfactory service.

In some cases, channel comparison condition 301 may include threshold conditions that correspond to measurement reporting trigger events for a UE 115. A base station 105 may provide a UE 115 with a measurement reporting configuration as part of an RRC configuration. The measurement reporting configuration may include parameters related to which neighbor cells and frequencies the UE 115 should measure, criteria for sending measurement reports, intervals for transmission of measurement reports (e.g., measurement gaps), and other related information. In some cases, measurement reports may be triggered by events related to the channel conditions of the serving cells or the neighbor cells.

For example, in an LTE system, a UE may be configured to send a first report (A1) when the serving cell becomes better than a threshold; a second report (A2) when the serving cell becomes worse than a threshold; a third report (A3) when a neighbor cell becomes better than the primary serving cell by an offset value; a fourth report (A4) when a neighbor cell becomes better than a threshold; a fifth report (A5) when the primary serving cell becomes worse than a threshold and a neighbor cell is simultaneously better than another (e.g., higher) threshold; a sixth report (A6) when a neighbor cell becomes better than a secondary serving cell by an offset value; a seventh report (B1) when a neighbor using a different radio access technology (RAT) becomes better than a threshold; or an eighth report (B2) when a primary serving cell becomes worse than a threshold and the inter-RAT neighbor becomes better than another threshold. In some cases, the UE 115 may wait for an interval known as time-to-trigger (TTT) to verify that the trigger condition persists before sending the report. In some cases, channel comparison condition 301 may have a corresponding TTT. Other reports may be sent periodically instead of being based on a trigger condition (e.g., every two seconds a UE 115 may transmit an indication of a transport block error rate).

A UE 115 may determine that an RLF is imminent by identifying a measurement reporting trigger, such as initiating an RLF timer based on an MRM trigger, and then determining whether a radio link condition indicative of an RLF has been satisfied before an expiration of the RLF timer. For example, the UE 115 may determine that no RLC layer ACK has been received for the MRM and that the timer has expired without receiving a handover command. As another example, the UE 115 may determine that a threshold number of UL messages, such as a threshold number of MRMs or other UL radio link signaling messages, have been transmitted without an RLC layer ACK. In some examples, a radio link condition indicative of an RLF may include at least one of a number of unsuccessful RLC layer retransmissions exceeding a threshold, a lack of UL grants, a scheduling request exhaustion, an N310 parameter, or the like. In some examples the UE 115 may also verify that channel comparison condition 301 is satisfied and initiate an RLF procedure, such as declaring RLF, based on one or more of detecting the condition indicative of RLF and the channel comparison condition 301.

FIG. 3B illustrates an example of a channel comparison condition 302 for early RLF declaration in accordance with aspects of the present disclosure. Channel comparison condition 302 may represent a comparison of a serving cell channel parameter 305-b and a target cell channel parameter 310-b. For example, the channels of the serving cell and the target cell may be compared with respect to measured values corresponding to RSRP, RSRQ, or RLM SNR.

Channel comparison condition 302 may be satisfied if the serving cell channel parameter 305-a is worse than the target cell channel parameter 310-a by an offset value 325. In some examples this may ensure that the target cell is sufficiently superior to the serving cell before initiating an RLF procedure, such as declaring RLF, and transitioning to the target cell. Other examples of channel comparison conditions are also possible.

According to the present disclosure, a UE 115 may determine that an RLF is imminent by identifying a measurement reporting trigger, such as initiating an RLF timer based on an MRM trigger. In some examples the UE 115 may transmit an MRM in response to identifying the measurement reporting trigger. The UE 115 may then detect a condition indicative of an RLF. In some examples the condition indicative of RLF may be detected before an expiration of the RLF timer. For example, the UE may determine that no RLC layer ACK has been received for the MRM and that the timer has expired without receiving a handover command. As another example, the UE may determine that a threshold number of UL messages, such as a threshold number of MRMs or other UL radio link signaling messages, have been transmitted without an RLC layer ACK. In some examples, a radio link condition that indicates or suggests an RLF may include a number of unsuccessful RLC layer retransmissions exceeding a threshold, the lack of an UL grant, a scheduling request exhaustion, an N310 parameter, or the like. In some examples the UE 115 may also verify that channel comparison condition 302 is satisfied and initiate an RLF procedure, such as declaring RLF, based on one or more of detecting the condition indicative of RLF and the channel comparison condition 302.

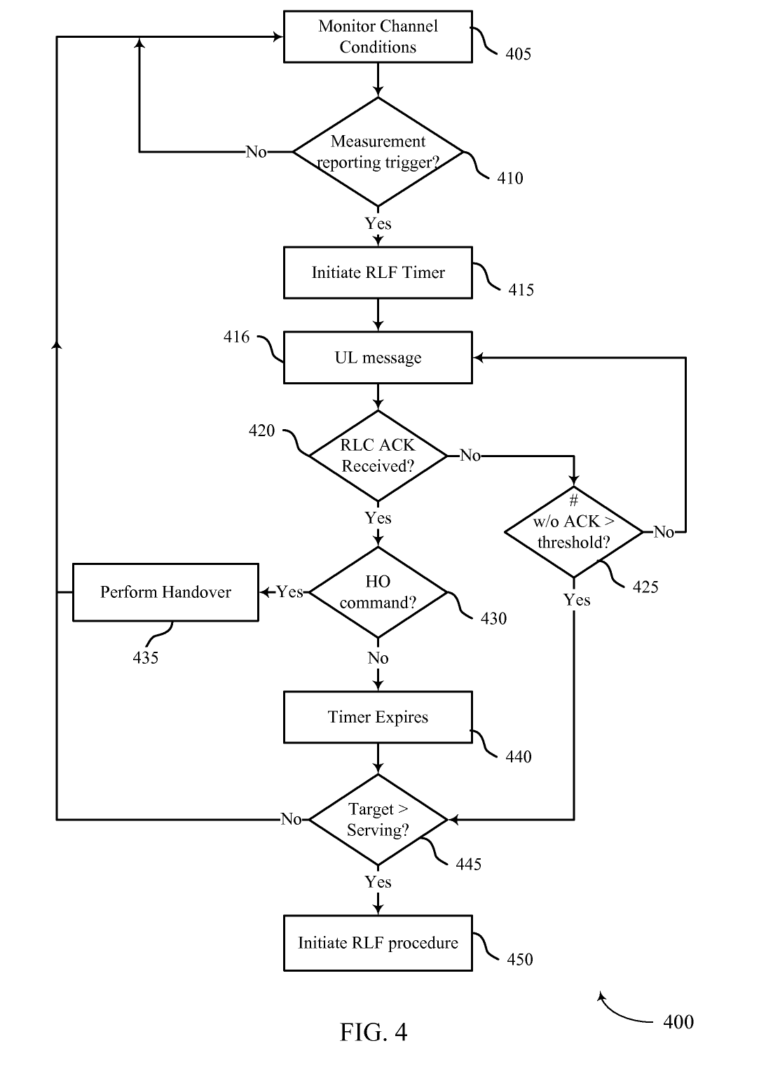

FIG. 4 illustrates an example of a decision flow 400 for early RLF declaration in accordance with aspects of the present disclosure. Decision flow 400 may represent steps performed by a UE 115 as described with reference to FIGS. 1-2. Decision flow 400 may include aspects of the channel comparison conditions as described with reference to FIGS. 3A and 3B.

At step 405, a UE 115 may monitor the channel conditions of a serving cell and one or more neighbor cells. For example, the UE 115 may receive a measurement configuration from a base station 105 as part of an RRC configuration message indicating a set of neighbor cells to monitor. During the monitoring, the UE 115 may measure values of the serving cell and one or more cells from the set of neighbor cells, the values corresponding to one or more channel parameters of the cells.

At step 410, the UE may identify a measurement reporting trigger, such as an MRM trigger event that has occurred or been triggered. In some examples, the measurement reporting trigger is an A1, A2, A3, A4, A5, B1, or B2 event in a measurement configuration of the UE. In some examples, if the UE 115 identifies a measurement report trigger (e.g., as described with reference to FIG. 3A), at step 415 the UE 115 may initiate an RLF timer based on an MRM trigger. At step 416, the UE 115 may transmit an UL message, such as an MRM or other UL radio link signaling message, based on the MRM trigger. The RLF timer may be used in conjunction with, or independent, of other timers used for declaration of RLF. For example, in an LTE system, a T310 timer may be triggered based on detection of a PHY layer problem at the serving cell (e.g., when a number of out-of-sync indications reaches a threshold). T312 may be another example of a timer that may be used in conjunction with the RLF timer. T312 may be triggered when T310 is running and a MRM is sent to the serving cell. In some examples a radio link condition indicative of RLF is based on an RLF timer, where the RLF timer may be based on a scheduling request (SR) exhaustion timer, a T310 timer, or an N310 parameter. For example, the RLF timer may be a minimum of the SR exhaustion parameter and the sum of the T310 timer value and an N310 value. In some cases, the RLF timer may be a fraction of this minimum. In some cases, the RLF timer may be shorter than the T310 and T312 timers to facilitate early RLF declaration.

At step 420, the UE 115 may detect whether a radio link condition indicative of an RLF has been satisfied, the determination prompted by the identified measurement reporting trigger. For example, this determination may be based on a determination of whether an RLC layer ACK for the UL message has been received, such as an RLC layer ACK in response to one or more MRMs or other UL radio link signaling messages. In various examples, if an RLC layer ACK is not received, it may be an indication that channel conditions for the serving cell have deteriorated significantly.

Even if an RLC layer ACK is received—or in some cases if the RLC layer ACK is not received—the UE 115 may otherwise determine that RLF is imminent. For example, at step 430, the UE 115 may wait for a handover command based on the UL radio link signaling message transmission. In some cases, even though an RLC layer ACK is received by the UE 115 (confirming that the serving cell received the MRM), the UE 115 may not receive an ensuing handover command based on a low channel quality for the serving cell.

If the handover command is received, at step 435 the UE 115 may perform the handover as directed. If, however, a handover command is not received at step 440 the UE 115 may determine that the RLF timer has expired. This lack of a handover command and the expiration of the RLF timer may satisfy a radio link condition indicative of an RLF.

As an additional or alternative method of determining that RLF is imminent, if at step 420 the RLC layer ACK for the UL message, such as an RLC layer ACK in response to an MRM message or other UL radio link signaling message, is not received, the UE 115 may increment a counter and then determine whether the counter for the number of RLC layer ACKs exceeds a threshold. If the threshold is not exceeded, the UE 115 may retransmit the UL message at step 416 and wait for another RLC layer ACK. But at step 425 if the number of UL messages transmitted without RLC layer ACK exceeds the threshold, the UE 115 may determine that the radio link condition for imminent RLF is satisfied. In some examples, the radio link condition may be further based on a traffic type indication. For example, the length of the RLF timer or other aspects of the radio link condition process may depend on whether the traffic type is a VoLTE traffic type (or another traffic type with a QoS standard).

Some examples may include step 445, where once the UE 115 has detected the condition indicative of a RLF (e.g., based on the RLF timer or the RLC layer ACK threshold); the UE 115 may optionally verify that a channel comparison condition has been satisfied based on a serving cell channel parameter and a target cell channel parameter. In some examples, verifying that the channel comparison condition has been satisfied includes: determining that the serving cell channel parameter is below a first threshold and determining that the target cell channel parameter is above a second threshold. In some examples, verifying that the channel comparison condition has been satisfied includes: determining that the target cell channel parameter exceeds the serving cell channel parameter by an offset value. For example, the UE 115 may verify a channel comparison condition as described with reference to FIG. 3A or 3B. The verification of the channel comparison condition may serve to ensure that channel conditions have not recovered at the serving cell or deteriorated at the target cell during the process of determining that RLF is imminent.

At step 450, if the UE has detected a condition indicative of RLF, and in some examples if the channel comparison condition is also satisfied, the UE 115 may initiate an RLF procedure based at least in part on the detected condition indicative of RLF, and where applicable based on the verification that the channel comparison condition has been satisfied. For example, at step 450 the UE may declare an RLF. In some examples the UE 115 may then establish a connection to the target cell after initiating the RLF procedure, such as after a declared RLF. In some cases, this may be an early RLF declaration that may mitigate any service disruption associated with the transition to the new cell. For example, it may enable the target cell to retrieve context for the UE 115 before the serving cell drops the context.

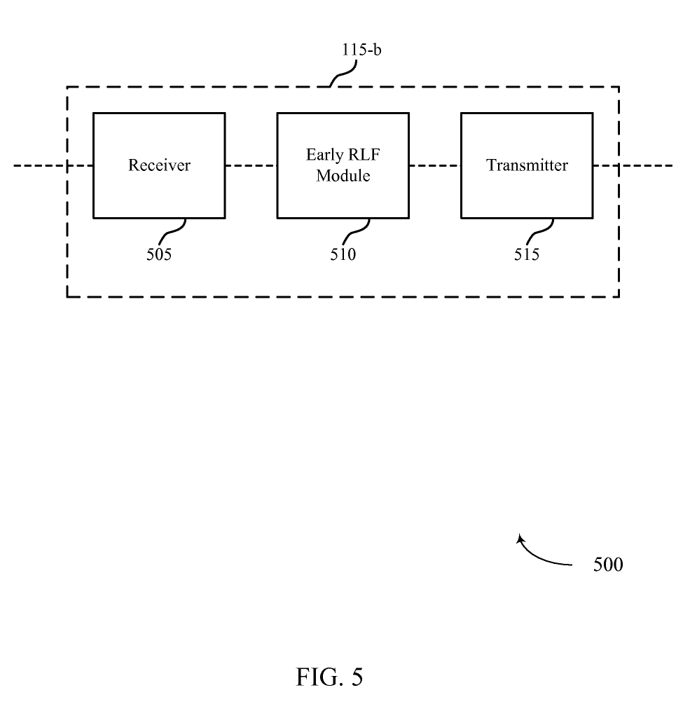

FIG. 5 shows a block diagram 500 of a UE 115-b that supports early RLF declaration in accordance with aspects of the present disclosure. UE 115-b may be an example of aspects of a UE 115 described with reference to FIGS. 1-4. UE 115-b may include a receiver 505, an early RLF module 510, and a transmitter 515. UE 115-b may also include a processor. Each of these components may be in communication with one another.

The receiver 505 may receive information such as packets, user data, or control information associated with various information channels (e.g., control channels, data channels, and information related to early RLF declaration, etc.). Information may be passed on to the early RLF module 510, and to other components of UE 115-b.

The early RLF module 510 may identify a measurement reporting trigger, such as an MRM trigger, and determine, in response to the MRM trigger, that a radio link condition indicative of an RLF has been satisfied. For instance, the early RLF module 510 may detect a condition indicative of RLF. The early RLF module 510 may then initiate an RLF procedure of the UE based at least in part on the determination that the radio link condition has been satisfied, such as declaring RLF. In some examples the early RLF module 510 may additionally verify that a channel comparison condition has been satisfied based on a serving cell channel parameter and a target cell channel parameter, with the initiation of an RLF procedure being based in part on the verification that the channel comparison condition has been satisfied.

The transmitter 515 may transmit signals received from other components of UE 115-b. In some examples, the transmitter 515 may be collocated with the receiver 505 in a transceiver module. The transmitter 515 may include a single antenna, or it may include a plurality of antennas. The transmitter 515 may transmit a UL message, such as an MRM or other UL radio link signaling message, following the identification of a measurement reporting trigger, such as an MRM trigger. The transmitter 515 may also transmit context information to a base station to facilitate a handover operation.

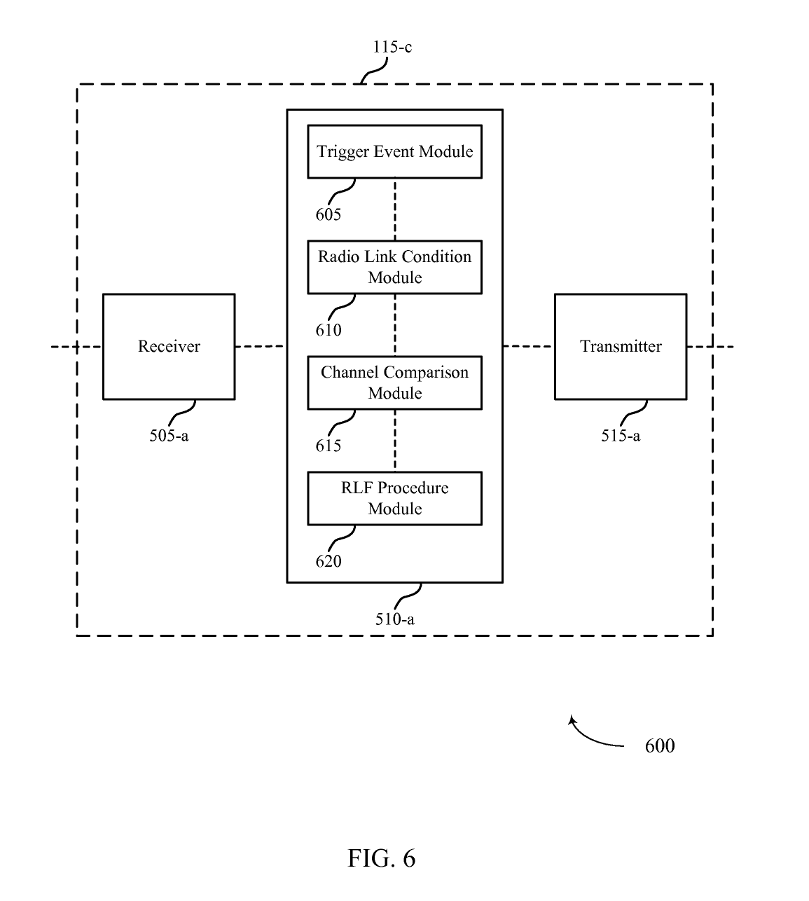

FIG. 6 shows a block diagram 600 of a UE 115-c that supports early RLF declaration in accordance with aspects of the present disclosure. UE 115-c may be an example of aspects of a UE 115 described with reference to FIGS. 1-5. UE 115-c may include a receiver 505-a, an early RLF module 510-a, or a transmitter 515-a. UE 115-c may include a processor. Each of these components may be in communication with one another. The early RLF module 510-a may include a trigger event module 605, a radio link condition module 610, a channel comparison module 615, and a RLF procedure module 620.

The receiver 505-a may receive information which may be passed on to the early RLF module 510-a, and to other components of UE 115-c. The early RLF module 510-a may perform the operations described with reference to FIG. 5. The transmitter 515-a may transmit signals received from other components of UE 115-c.

The trigger event module 605 may identify a measurement reporting trigger, such as an MRM trigger, as described with reference to FIGS. 2-4. In some examples, the measurement reporting trigger may be an A1, A2, A3, A4, A5, B1 or B2 event in a measurement configuration of the UE.

The radio link condition module 610 may detect a condition indicative of an RLF, such as determining that a radio link condition indicative of an RLF has been satisfied. The detection may be prompted by the identified measurement reporting trigger as described with reference to FIGS. 2-4. In some examples, the radio link condition may be detected based on a determination that an RLC layer ACK has not been received in response to an UL message and the determination that the handover command has not been received before the expiration of an RLF timer. In some examples the radio link condition module 610 may determine that a threshold number of UL messages, such as MRMs and/or other UL radio link signaling messages, have been transmitted without an RLC layer ACK. In some examples, the radio link condition module 610 may determine any of: a number of unsuccessful RLC layer retransmissions exceeding a threshold, a lack of UL grants, a scheduling request exhaustion, an N310 parameter, or the like. The detecting of the radio link condition may, for instance, be further based on an application layer parameter such as a QoS class identifier (QCI), a guaranteed bit rate (GBR), or a traffic type indication. In some examples, the traffic type may be a VoLTE traffic type. In some examples, the radio link condition may be further based on a PHY layer BLER, a MAC BLER, or an RLC error rate.

In some examples the channel comparison module 615 may verify that a channel comparison condition has been satisfied based on a serving cell channel parameter and a target cell channel parameter. For example, the channel comparison module 615 may measure, or otherwise receive from measurements collected by the receiver 505-a, the early RLF module 510-a, or some other portion of the UE 115-c, a value corresponding to a serving cell channel parameter and a value corresponding to a target cell channel parameter. These values may be compared directly to one another, compared directly to one or more thresholds, or otherwise support a calculation of a serving cell channel parameter and a target cell channel parameter as used in a channel comparison condition. For example, the measured value corresponding to the serving cell channel parameter and the measured value corresponding to the target cell channel parameter may be used by the channel comparison module 615 to perform a channel comparison.

In some examples, verifying that the channel comparison condition has been satisfied includes determining that the serving cell channel parameter is below a first threshold and determining that the target cell channel parameter is above a second threshold. In some examples, verifying that the channel comparison condition has been satisfied includes determining that the target cell channel parameter exceeds the serving cell channel parameter by an offset value. In some examples, the serving cell channel parameter may be an RSRQ parameter or an RLM SNR. Likewise, the target cell channel parameter may be an RSRQ parameter or an RLM SNR. Additionally or alternatively, the target cell may be a Wi-Fi cell (e.g., a cell configured to operate according to the Institute of Electrical and Electronics Engineers (IEEE) 802.11 family of standards).

The RLF procedure module 620 may initiate an RLF procedure based on detecting the radio link condition indicative of RLF as described with reference to FIGS. 2-5. In some examples, the RLF procedure module 620 may initiate an RLF procedure based additionally on the verification that the channel comparison condition has been satisfied as described above with reference to FIGS. 2-4. In some examples, initiating the RLF procedure may include declaring RLF.

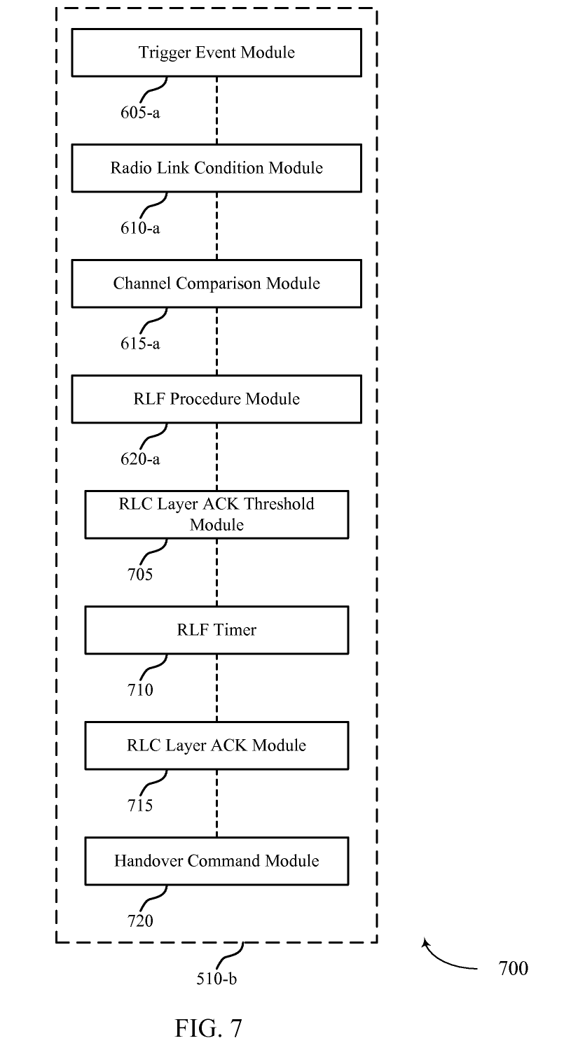

FIG. 7 shows a block diagram 700 of an early RLF module 510-b that supports early RLF declaration in accordance with aspects of the present disclosure. The early RLF module 510-b may be an example of aspects of an early RLF module 510 described with reference to FIGS. 5-6. The early RLF module 510-b may include a trigger event module 605-a, a radio link condition module 610-a, a channel comparison module 615-a, and a RLF procedure module 620-a. Each of these modules may perform the corresponding functions as described with reference to FIG. 6. The early RLF module 510-b may include a RLC layer ACK threshold module 705, a RLF timer 710, a RLC layer ACK module 715, and a handover command module 720.

The RLC layer ACK threshold module 705 may determine that a number of UL messages, such as MRMs or other UL radio link signaling messages, transmitted without RLC layer ACK exceeds a threshold. A condition indicative of RLF may be determined based on the number of UL messages transmitted without RLC layer ACK exceeding the threshold as described with reference to FIGS. 2-5.

The RLF timer 710 may initiate an RLF timer based on the measurement reporting trigger, such as an MRM trigger, as described with reference to FIGS. 2-4. The RLF timer 710 may determine that the RLF timer has expired as described with reference to FIGS. 2-4. In some examples, the RLF timer may be based on an SR exhaustion timer, a T310 timer, or an N310 parameter.

The RLC layer ACK module 715 may determine that an RLC layer ACK for the UL message has not been received as described with reference to FIGS. 2-4.

The handover command module 720 may determine that a handover command has not been received before the expiration of the RLF timer as described with reference to FIGS. 2-4.

The various components of the UEs 115 as described with reference to FIGS. 2, 3A, 3B, 4, 5 and 6, and the early RLF modules 510 as described with reference to FIGS. 6 and 7 may, individually or collectively, be implemented with at least one application-specific integrated circuit (ASIC) adapted to perform some or all of the applicable functions in hardware. Alternatively, the functions may be performed by one or more other processing units (or cores), on at least one integrated circuit (IC). In other embodiments, other types of integrated circuits may be used (e.g., Structured/Platform ASICs, an FPGA, or another semi-custom IC), which may be programmed in any manner known in the art. The functions of each unit may be implemented, in whole or in part, with instructions embodied in a memory, formatted to be executed by one or more general or application-specific processors.

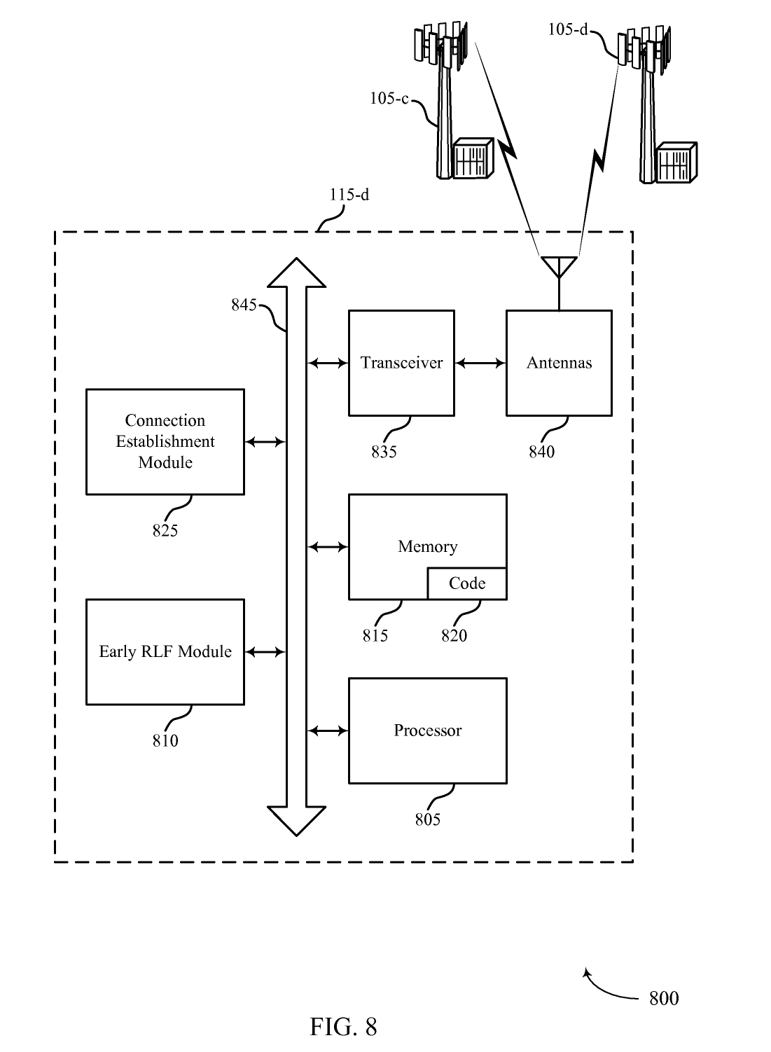

FIG. 8 shows a diagram of a system 800 including a UE 115 that supports early RLF declaration in accordance with aspects of the present disclosure. System 800 may include UE 115-d, which may be an example of one or more aspects of UEs 115 as described with reference to FIGS. 1 through 7. UE 115-d may include an early RLF module 810, which may be an example of one or more aspects of early RLF modules 510 described with reference to FIGS. 5 through 7. UE 115-d may include a connection establishment module 825. UE 115-d may include components for bi-directional voice and data communications including components for transmitting communications and components for receiving communications. For example, UE 115-d may communicate bi-directionally with a base station 105-c or a base station 105-d.

The connection establishment module 825 may establish a connection to a serving cell or a target cell. For example, connection establishment module 825 may establish a connection to a target cell based on an initiated RLF procedure, such as a declared RLF, as described with reference to any of FIGS. 2 through 7. In some cases, the connection establishment module 825 may establish a connection based on a RACH process as described with reference to FIG. 1.

UE 115-d may include a processor module 805, and memory 815 (including code 820), a transceiver 835, and one or more antenna(s) 840, each of which may communicate, directly or indirectly, with one another (e.g., via buses 845). The transceiver 835 may communicate bi-directionally, via the antenna(s) 840 and wired or wireless links, with one or more networks, as described above. For example, the transceiver 835 may communicate bi-directionally with a base station 105 and another UE 115. The transceiver 835 may include a modem to modulate the packets and provide the modulated packets to the antenna(s) 840 for transmission, and to demodulate packets received from the antenna(s) 840. While UE 115-d may include one antenna 840, UE 115-d may have more than one antenna 840 capable of concurrently transmitting or receiving multiple wireless transmissions.

The memory 815 may include random access memory (RAM) and read only memory (ROM). Code 820 may be computer-readable and computer-executable, and may be stored in the memory 815 as software, firmware, or some combination of software and firmware. Code 820 may include instructions that, when executed by the processor module 805, cause elements of the UE 115-d to perform various functions described herein (e.g., early RLF declaration, etc.). Alternatively, the code 820 may not be directly executable by the processor module 805 but cause a computer (e.g., when compiled and executed) to perform functions described herein. The processor module 805 may include an intelligent hardware device, (e.g., a central processing unit (CPU), a microcontroller, an ASIC, etc.)

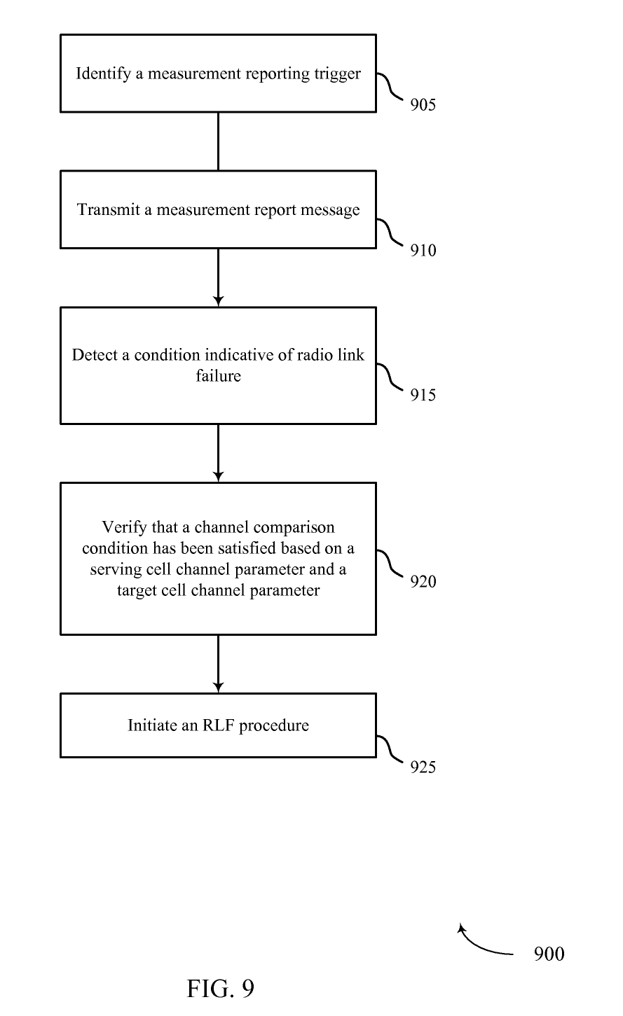

FIG. 9 shows a flowchart illustrating a method 900 for early RLF declaration in accordance with aspects of the present disclosure. The operations of method 900 may be implemented by one of the UEs 115 or its components as described with reference to FIGS. 1 through 8. For example, the operations of method 900 may be performed by an early RLF module 510 or 810 as described with reference to FIGS. 5 through 8. In some examples, a UE 115 may include a processor which executes a set of instructions to control the functional elements of the UE 115 to perform the functions described below. Additionally or alternatively, the UE 115 may perform aspects the functions described below using special-purpose hardware.

At block 905, the UE 115 may identify a measurement reporting trigger, such as an MRM trigger, as described with reference to FIGS. 2 through 8. In various examples, the operations of block 905 may be performed by an early RLF module 510 or 810 as described with reference to FIG. 8, or a trigger event module 605 as described with reference to FIG. 6 or 7.

At block 910, the UE 115 may transmit a measurement report message (MRM) as described with reference to FIGS. 2 through 8. In various examples the operations of block 910 may be performed by early RLF modules 510 as described with reference to FIG. 5, 6, or 7, a transmitter 515 as described with reference to 5 or 6, transceiver 835 and antenna 840 as described with reference to FIG. 8.

At block 915, the UE 115 may detect a radio link condition indicative of a RLF as described with reference to FIGS. 2 through 8. The radio link condition may include a determination that no RLC layer ACK has been received for a UL, such as an MRM or other UL radio link signaling message, and that an RLF timer has expired without receiving a handover command. In some examples, the UE 115 may determine that a threshold number of UL messages, such as MRMs or other UL radio link signaling messages, have been transmitted without an RLC layer ACK. In some examples, a radio link condition that indicative of an RLF may include a number of unsuccessful RLC layer retransmissions exceeding a threshold, a lack of UL grants, a scheduling request exhaustion, an N310 parameter, or some combination of these conditions. In various examples, the operations of block 915 may be performed by an early RLF module 510 or 810 as described with reference to FIG. 8, or a radio link condition module 610 as described with reference to FIG. 6 or 7.

At block 920, the UE 115 may optionally verify that a channel comparison condition has been satisfied based on a serving cell channel parameter and a target cell channel parameter, as described with reference to FIGS. 2 through 8. In various examples, the operations of block 920 may be performed by an early RLF module 510 or 810 as described with reference to FIG. 8, or a channel comparison module 615 as described with reference to FIG. 6 or 7.

At block 925, the UE 115 may initiate an RLF procedure based on the determination that the radio link condition has been satisfied, and in some examples additionally based on the verification that the channel comparison condition has been satisfied, as described with reference to FIGS. 2 through 8. In some examples, initiating an RLF procedure may include declaring RLF. In various examples, the operations of block 925 may be performed by an early RLF module 510 or 810 as described with reference to FIG. 8, or a RLF procedure module 620 as described with reference to FIG. 6 or 7.

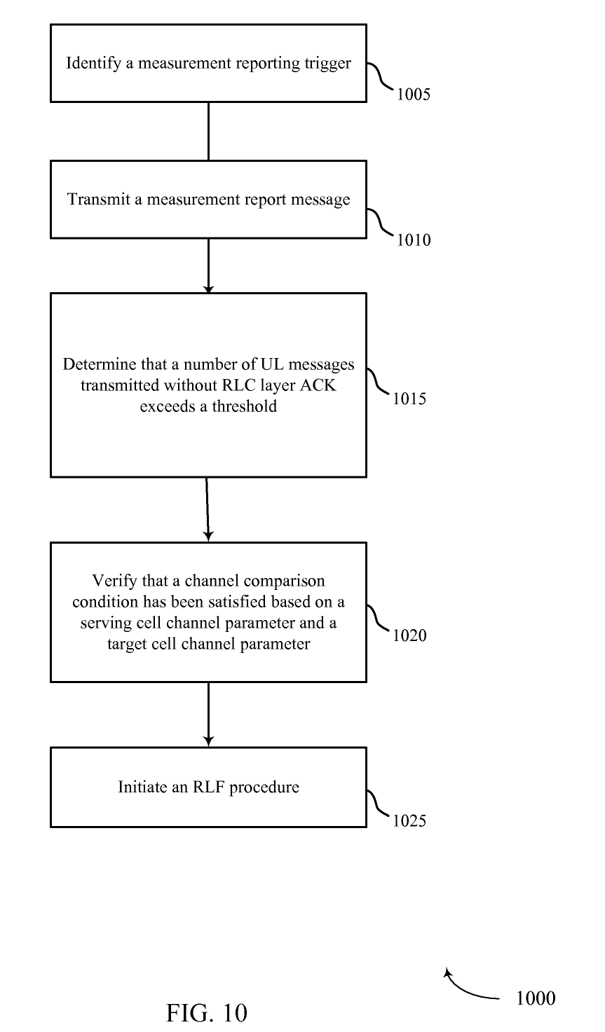

FIG. 10 shows a flowchart illustrating a method 1000 for early RLF declaration in accordance with aspects of the present disclosure. The operations of method 1000 may be implemented by one of the UEs 115 or its components as described with reference to FIGS. 1 through 8. For example, the operations of method 1000 may be performed by an early RLF module 510 or 810 as described with reference to FIGS. 5 through 8. In some examples, a UE 115 may include a processor which executes a set of instructions to control the functional elements of the UE 115 to perform the functions described below. Additionally or alternatively, the UE 115 may perform aspects the functions described below using special-purpose hardware. The method 1000 may incorporate aspects of method 900 as described with reference to FIG. 9.

At block 1005, the UE 115 may identify a measurement reporting trigger, such as an MRM trigger, as described with reference to FIGS. 2 through 8. In various examples, the operations of block 1005 may be performed by an early RLF module 510 or 810 as described with reference to FIG. 8, or a trigger event module 605 as described with reference to FIG. 6 or 7.

At block 1010, the UE 115 may transmit a measurement report message (MRM) as described with reference to FIGS. 2 through 8. In various examples the operations of block 1010 may be performed by early RLF modules 510 as described with reference to FIG. 5, 6, or 7, a transmitter 515 as described with reference to 5 or 6, transceiver 835 and antenna 840 as described with reference to FIG. 8.

At block 1015, the UE 115 may determine, in response to the measurement reporting trigger, that a number of UL messages, such as MRMs or other UL radio link signaling messages, transmitted without RLC layer ACK exceeds a threshold, as described with reference to FIGS. 2 through 8. In some examples, the operations of block 1015 may be performed by the radio link condition module 610 as described with reference to FIG. 6. Thus, in various examples, the operations of block 1015 may be performed by an early RLF module 510 or 810 as described with reference to FIG. 8, or a RLC layer ACK threshold module 705 as described with reference to FIG. 7.

At block 1020, the UE 115 may optionally verify that a channel comparison condition has been satisfied based on a serving cell channel parameter and a target cell channel parameter as described with reference to FIG. 2-through 8. In various examples, the operations of block 1020 may be performed by an early RLF module 510 or 810 as described with reference to FIG. 8, or a channel comparison module 615 as described with reference to FIG. 6 or 7.

At block 1025, the UE 115 may initiate an RLF procedure based on the determination that the radio link condition has been satisfied, and in some examples additionally based on the verification that the channel comparison condition has been satisfied, as described with reference to FIGS. 2 through 8. In some examples, initiating an RLF procedure may include declaring RLF. In various examples, the operations of block 1025 may be performed by an early RLF module 510 or 810 as described with reference to FIG. 8, or a RLF procedure module 620 as described with reference to FIG. 6 or 7.

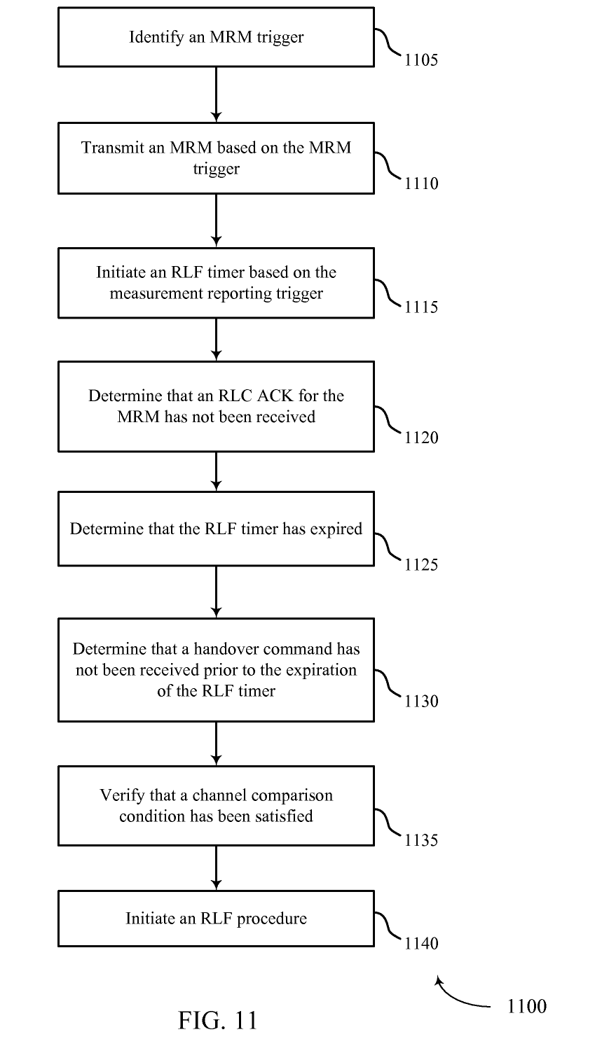

FIG. 11 shows a flowchart illustrating a method 1100 for early RLF declaration in accordance with aspects of the present disclosure. The operations of method 1100 may be implemented by one of the UEs 115 or its components as described with reference to FIGS. 1 through 8. For example, the operations of method 1100 may be performed by an early RLF module 510 or 810 as described with reference to FIGS. 5 through 8. In some examples, a UE 115 may include a processor which executes a set of instructions to control the functional elements of the UE 115 to perform the functions described below. Additionally or alternatively, the UE 115 may perform aspects the functions described below using special-purpose hardware. The method 1100 may incorporate aspects of methods 900 and 1000 as described with reference to FIGS. 9 and 10.

At block 1105, the UE 115 may identify an MRM trigger as described with reference to FIGS. 2 through 8. In various examples, the operations of block 1105 may be performed by an early RLF module 510 or 810 as described with reference to FIG. 8, or a trigger event module 605 as described with reference to FIG. 6 or 7.

At block 1110, the UE 115 may transmit an MRM based on the MRM trigger as described with reference to FIGS. 2 through 8. In various examples, the operations of block 1110 may be performed by early RLF modules 510 as described with reference to FIG. 5, 6, or 7, a transmitter 515 as described with reference to 5 or 6, transceiver 835 and antenna 840 as described with reference to FIG. 8.

At block 1115, the UE 115 may initiate an RLF timer based on the MRM trigger as described with reference to FIGS. 2 through 8. In various examples, the operations of block 1115 may be performed by an early RLF module 510 or 810 as described with reference to FIG. 8, or a RLF timer 710 as described with reference to FIG. 7.

At block 1120, the UE 115 may determine that an RLC layer ACK for the MRM has not been received as described with reference to FIGS. 2 through 8. In various examples, the operations of block 1120 may be performed by an early RLF module 510 or 810 as described with reference to FIG. 8, or a RLC layer ACK module 715 as described with reference to FIG. 7.

At block 1125, the UE 115 may determine that the RLF timer has expired as described with reference to FIGS. 2 through 8. In various examples, the operations of block 1125 may be performed by an early RLF module 510 or 810 as described with reference to FIG. 8, or a RLF timer 710 as described with reference to FIG. 7.

At block 1130, the UE 115 may determine that a handover command has not been received before the expiration of the RLF timer. A radio link condition may be based on the determination that the RLC layer ACK has not been received and the determination that the handover command has not been received before the expiration of the RLF timer as described with reference to FIGS. 2 through 8. In various examples, the operations of block 1130 may be performed by an early RLF module 510 or 810 as described with reference to FIG. 8, or a handover command module 720 as described with reference to FIG. 7.

At block 1135, the UE 115 may verify that a channel comparison condition has been satisfied based on a serving cell channel parameter and a target cell channel parameter, the verification prompted by the determination that the radio link condition has been satisfied as described with reference to FIGS. 2 through 8. In various examples, the operations of block 1135 may be performed by an early RLF module 510 or 810 as described with reference to FIG. 8, or a channel comparison module 615 as described with reference to FIG. 6 or 7.

At block 1140, the UE 115 may initiate an RLF procedure based on the determination that the radio link condition has been satisfied, and in some examples based on the verification that the channel comparison condition has been satisfied as described with reference to FIGS. 2 through 8. In some examples initiating the RLF procedure may include declaring an RLF. In various examples, the operations of block 1140 may be performed by an early RLF module 510 or 810 as described with reference to FIG. 8, or a RLF procedure module 620 as described with reference to FIG. 6 or 7.

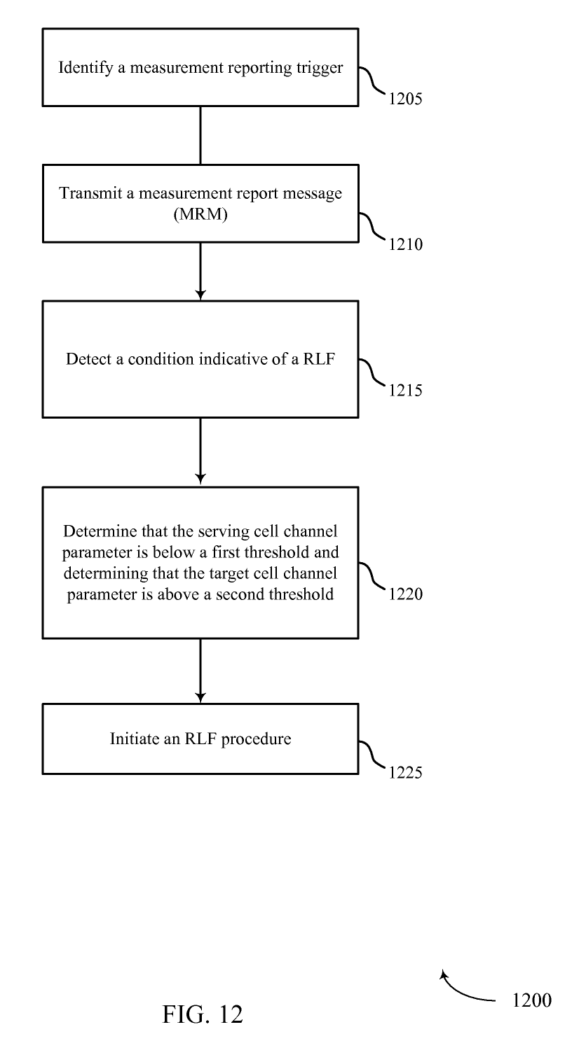

FIG. 12 shows a flowchart illustrating a method 1200 for early RLF declaration in accordance with aspects of the present disclosure. The operations of method 1200 may be implemented by any one of the UEs 115 or its components as described with reference to FIGS. 1 through 8. For example, the operations of method 1200 may be performed by an early RLF module 510 or 810 as described with reference to FIGS. 5 through 8. In some examples, a UE 115 may include a processor which executes a set of instructions to control the functional elements of the UE 115 to perform the functions described below. Additionally or alternatively, the UE 115 may perform aspects the functions described below using special-purpose hardware. The method 1200 may incorporate aspects of methods 900, 1000, and 1100 described with reference to FIGS. 9 through 11.

At block 1205, the UE 115 may identify a measurement reporting trigger, such as an MRM trigger, as described with reference to FIGS. 2 through 8. In various examples, the operations of block 1205 may be performed by an early RLF module 510 or 810 as described with reference to FIG. 8, or a trigger event module 605 as described with reference to FIG. 6 or 7.

At block 1210, the UE 115 may transmit a measurement report message (MRM) as described with reference to FIGS. 2 through 8. In various examples the operations of block 1210 may be performed by early RLF modules 510 as described with reference to FIG. 5, 6, or 7, a transmitter 515 as described with reference to 5 or 6, transceiver 835 and antenna 840 as described with reference to FIG. 8.

At block 1215, the UE 115 may detect a radio link condition indicative of a RLF as described with reference to FIGS. 2 through 8. The radio link condition may include a determination that no RLC layer ACK has been received for a UL, such as an MRM or other UL radio link signaling message, and that an RLF timer has expired without receiving a handover command. In some examples, the UE 115 may determine that a threshold number of UL messages, such as MRMs or other UL radio link signaling messages, have been transmitted without an RLC layer ACK. In some examples, a radio link condition that indicative of an RLF may include a number of unsuccessful RLC layer retransmissions exceeding a threshold, a lack of UL grants, a scheduling request exhaustion, an N310 parameter, or some combination of these conditions. In various examples, the operations of block 1215 may be performed by an early RLF module 510 or 810 as described with reference to FIG. 8, or a radio link condition module 610 as described with reference to FIG. 6 or 7.

At block 1220, the UE 115 may determine that the serving cell channel parameter is below a first threshold and determining that the target cell channel parameter is above a second threshold as described above with reference to FIGS. 2-4. In some examples, the operations of block 1220 may be performed by an early RLF module 510 or 810 as described with reference to FIG. 8, or a channel comparison module 615 as described with reference to FIG. 6 or 7.

At block 1225, the UE 115 may initiate an RLF procedure based on the determination that the radio link condition has been satisfied, and in some examples additionally based on the verification that the channel comparison condition has been satisfied, as described with reference to FIGS. 2 through 8. In some examples, initiating an RLF procedure may include declaring RLF. In various examples, the operations of block 1225 may be performed by an early RLF module 510 or 810 as described with reference to FIG. 8, or a RLF procedure module 620 as described with reference to FIG. 6 or 7.

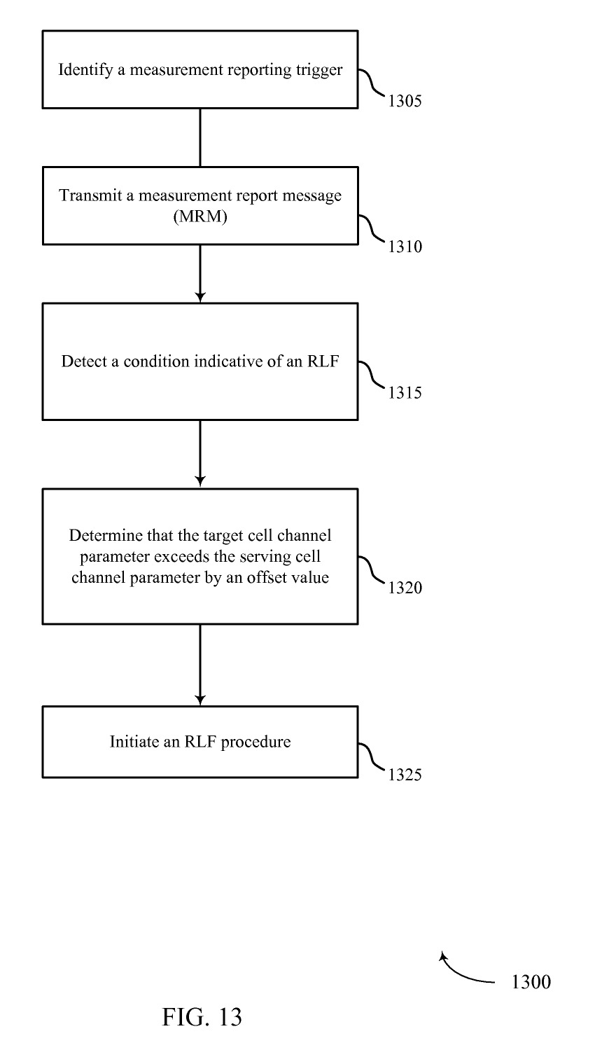

FIG. 13 shows a flowchart illustrating a method 1300 for early RLF declaration in accordance with aspects of the present disclosure. The operations of method 1300 may be implemented by a UE 115 or its components as described with reference to FIGS. 1-8. For example, the operations of method 1300 may be performed by the early RLF module 510 as described with reference to FIGS. 5-8. In some examples, a UE 115 may execute a set of codes to control the functional elements of the UE 115 to perform the functions described below. Additionally or alternatively, the UE 115 may perform aspects the functions described below using special-purpose hardware. The method 1300 may incorporate aspects of methods 900, 1000, 1100, and 1200 described with reference to FIGS. 9-12.

At block 1305, the UE 115 may identify a measurement reporting trigger, such as an MRM trigger, as described with reference to FIGS. 2 through 8. In various examples, the operations of block 1305 may be performed by an early RLF module 510 or 810 as described with reference to FIG. 8, or a trigger event module 605 as described with reference to FIG. 6 or 7.

At block 1310, the UE 115 may transmit a measurement report message (MRM) as described with reference to FIGS. 2 through 8. In various examples the operations of block 1310 may be performed by early RLF modules 510 as described with reference to FIG. 5, 6, or 7, a transmitter 515 as described with reference to 5 or 6, transceiver 835 and antenna 840 as described with reference to FIG. 8.

At block 1315, the UE 115 may detect a radio link condition indicative of a RLF as described with reference to FIGS. 2 through 8. The radio link condition may include a determination that no RLC layer ACK has been received for a UL, such as an MRM or other UL radio link signaling message, and that an RLF timer has expired without receiving a handover command. In some examples, the UE 115 may determine that a threshold number of UL messages, such as MRMs or other UL radio link signaling messages, have been transmitted without an RLC layer ACK. In some examples, a radio link condition that indicative of an RLF may include a number of unsuccessful RLC layer retransmissions exceeding a threshold, a lack of UL grants, a scheduling request exhaustion, an N310 parameter, or some combination of these conditions. In various examples, the operations of block 1315 may be performed by an early RLF module 510 or 810 as described with reference to FIG. 8, or a radio link condition module 610 as described with reference to FIG. 6 or 7.

At block 1320, the UE 115 may determine that the target cell channel parameter exceeds the serving cell channel parameter by an offset value as described with reference to FIGS. 2-4. In some examples, the operations of block 1315 may be performed by an early RLF module 510 or 810 as described with reference to FIG. 8, or a channel comparison module 615 as described with reference to FIG. 6 or 7.

At block 1325, the UE 115 may initiate an RLF procedure based on the determination that the radio link condition has been satisfied, and in some examples additionally based on the verification that the channel comparison condition has been satisfied, as described with reference to FIGS. 2 through 8. In some examples, initiating an RLF procedure may include declaring RLF. In various examples, the operations of block 1225 may be performed by an early RLF module 510 or 810 as described with reference to FIG. 8, or a RLF procedure module 620 as described with reference to FIG. 6 or 7.

Thus, methods 900, 1000, 1100, 1200, and 1300 may provide for early RLF declaration. It should be noted that methods 900, 1000, 1100, 1200, and 1300 describe possible implementation, and that the operations and the steps may be rearranged or otherwise modified such that other implementations are possible. In some examples, aspects from two or more of the methods 900, 1000, 1100, 1200, and 1300 may be combined.

The detailed description set forth above in connection with the appended drawings describes example embodiments and does not represent all the embodiments that may be implemented or that are within the scope of the claims. The term “exemplary,” which may be used in this description, means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

As used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an ASIC, a field-programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may be physically located at various positions, including being distributed such that portions of functions are implemented at different physical locations. As used herein, including in the claims, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates an inclusive list such that, for example, a phrase referring to “at least one of” a list of items refers to any combination of those items, including single members. As an example, “at least one of: A, B, or C” is intended to cover A, B, C, A-B, A-C, B-C, and A-B-C, as well as any combination with multiples of the same element (e.g., A-A A-A-A, A-A-B, A-A-C, A-B-B, A-C-C, B-B, B-B-B, B-B-C, C-C, and C-C-C or any other ordering of A, B, and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP Long Term Evolution (LTE) and LTE-Advanced (LTE-A) are new releases of Universal Mobile Telecommunications System (UMTS) that use E-UTRA. UTRA, E-UTRA, UMTS, LTE, LTE-A, and Global System for Mobile communications (GSM) are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description above, however, describes an LTE system for purposes of example, and LTE terminology is used in much of the description above, although the techniques are applicable beyond LTE applications.

What is claimed is:

1. A method of wireless communication at a user equipment (UE), comprising:
identifying a measurement reporting trigger;
transmitting a measurement report message (MRM) in response to identifying the measurement reporting trigger;
detecting a condition indicative of a radio link failure (RLF) based at least in part on a number of uplink (UL) messages transmitted without radio link control (RLC) layer acknowledgement (ACK), the number of UL messages comprising the transmitted MRM, or a number of unsuccessful RLC layer retransmissions after the measurement reporting trigger; and
initiating an RLF procedure of the UE based at least in part on detecting the condition indicative of a RLF.

2. The method of claim 1, further comprising:
measuring a value corresponding to a serving cell channel parameter;
measuring a value corresponding to a target cell channel parameter;
verifying that a channel comparison condition has been satisfied based at least in part on the value corresponding to the serving cell channel parameter and the value corresponding to the target cell channel parameter; and
wherein initiating the RLF procedure is based at least in part on a result of verifying that the channel comparison condition has been satisfied.

3. The method of claim 2, wherein verifying that the channel comparison condition has been satisfied comprises:
determining that the serving cell channel parameter is below a first threshold and determining that the target cell channel parameter is above a second threshold.

4. The method of claim 2, wherein verifying that the channel comparison condition has been satisfied comprises:
determining that the target cell channel parameter exceeds the serving cell channel parameter by at least an offset value.

5. The method of claim 2, wherein the serving cell channel parameter comprises a reference signal received quality (RSRQ) parameter or a radio link monitoring signal to noise ratio (RLM SNR).

6. The method of claim 2, wherein the target cell channel parameter comprises a reference signal received quality (RSRQ) parameter or a radio link monitoring signal to noise ratio (RLM SNR).

7. The method of claim 1, further comprising:
establishing a connection to a target cell after initiating the RLF procedure of the UE.

8. The method of claim 1, wherein the measurement reporting trigger is an A1, A2, A3, A4, A5, B1, or B2 event in a measurement configuration of the UE.

9. The method of claim 1, wherein the detecting a condition indicative of a RLF is based at least in part on a traffic type indication.

10. The method of claim 1, wherein the detecting a condition indicative of a RLF is based at least in part on a physical (PHY) layer block error rate (BLER), a medium access control (MAC) BLER or a RLC error rate.

11. An apparatus for wireless communication at a user equipment (UE), comprising:
a processor;
memory in electronic communication with the processor; and
instructions stored in the memory and operable, when executed by the processor, to cause the apparatus to:
identify a measurement reporting trigger;
transmit a measurement report message (MRM) in response to identifying the measurement reporting trigger;
detect a condition indicative of a radio link failure (RLF) based at least in part on a number of uplink (UL) messages transmitted without radio link control (RLC) layer acknowledgement (ACK), the number of UL messages comprising the transmitted MRM, or a number of unsuccessful RLC layer retransmissions after the measurement reporting trigger; and
initiate an RLF procedure of the UE based at least in part on detecting the condition indicative of a RLF.

12. The apparatus of claim 11, wherein the instructions are executable by the processor to cause the apparatus to:
measure a value corresponding to a serving cell channel parameter;
measure a value corresponding to a target cell channel parameter;
verify that a channel comparison condition has been satisfied based at least in part on the value corresponding to the serving cell channel parameter and the value corresponding to the target cell channel parameter; and
initiate the RLF procedure based at least in part on a result of verifying that the channel comparison condition has been satisfied.

13. The apparatus of claim 12, wherein the instructions are executable by the processor to cause the apparatus to:
determine that the serving cell channel parameter is below a first threshold and determining that the target cell channel parameter is above a second threshold.

14. The apparatus of claim 12, wherein the instructions are executable by the processor to cause the apparatus to:
determine that the target cell channel parameter exceeds the serving cell channel parameter by at least an offset value.

15. The apparatus of claim 12, wherein the serving cell channel parameter comprises a reference signal received quality (RSRQ) parameter or a radio link monitoring signal to noise ratio (RLM SNR).

16. The apparatus of claim 12, wherein the target cell channel parameter comprises a reference signal received quality (RSRQ) parameter or a radio link monitoring signal to noise ratio (RLM SNR).

17. The apparatus of claim 11, wherein the instructions are executable by the processor to cause the apparatus to:
establish a connection to a target cell after initiating the RLF procedure of the UE.

18. The apparatus of claim 11, wherein the measurement reporting trigger is an A1, A2, A3, A4, A5, B1, or B2 event in a measurement configuration of the UE.

19. The apparatus of claim 11, wherein the detecting a condition indicative of a RLF is based at least in part on a traffic type indication.

20. The apparatus of claim 11, wherein the detecting a condition indicative of a RLF is based at least in part on a physical (PHY) layer block error rate (BLER), a medium access control (MAC) BLER or a RLC error rate.

21. An apparatus for wireless communication at a user equipment (UE), comprising:
means for identifying a measurement reporting trigger;
means for transmitting a measurement report message (MRM) in response to identifying the measurement reporting trigger;
means for detecting a condition indicative of a radio link failure (RLF) based at least in part on a number of uplink (UL) messages transmitted without radio link control (RLC) layer acknowledgement (ACK), the number of UL messages comprising the transmitted MRM, or a number of unsuccessful RLC layer retransmissions after the measurement reporting trigger; and
means for initiating an RLF procedure of the UE based at least in part on detecting the condition indicative of a RLF.

22. The apparatus of claim 21, further comprising:
means for measuring a value corresponding to a serving cell channel parameter;
means for measuring a value corresponding to a target cell channel parameter;
means for verifying that a channel comparison condition has been satisfied based at least in part on the value corresponding to the serving cell channel parameter and the value corresponding to the target cell channel parameter; and
wherein the means for initiating the RLF procedure is operable based at least in part on a result of verifying that the channel comparison condition has been satisfied.

23. The apparatus of claim 22, wherein the means for verifying that the channel comparison condition has been satisfied comprises:
means for determining that the serving cell channel parameter is below a first threshold and determining that the target cell channel parameter is above a second threshold.

24. The apparatus of claim 22, wherein the means for verifying that the channel comparison condition has been satisfied comprises:
means for determining that the target cell channel parameter exceeds the serving cell channel parameter by at least an offset value.

25. The apparatus of claim 22, wherein the serving cell channel parameter comprises a reference signal received quality (RSRQ) parameter or a radio link monitoring signal to noise ratio (RLM SNR).

26. The apparatus of claim 22, wherein the target cell channel parameter comprises a reference signal received quality (RSRQ) parameter or a radio link monitoring signal to noise ratio (RLM SNR).

27. The apparatus of claim 21, further comprising:
means for establishing a connection to a target cell after initiating the RLF procedure of the UE.

28. The apparatus of claim 21, wherein the measurement reporting trigger is an A1, A2, A3, A4, A5, B1, or B2 event in a measurement configuration of the UE.

29. The apparatus of claim 21, wherein the wherein the means for detecting a condition indicative of a RLF is operable based at least in part on a traffic type indication.

30. A non-transitory computer-readable medium storing code for wireless communication at a user equipment (UE), the code comprising instructions executable to:
identify a measurement reporting trigger;
transmit a measurement report message (MRM) in response to identifying the measurement reporting trigger;
detect a condition indicative of a radio link failure (RLF) based at least in part on a number of uplink (UL) messages transmitted without radio link control (RLC) layer acknowledgement (ACK), the number of UL messages comprising the transmitted MRM, or a number of unsuccessful RLC layer retransmissions after the measurement reporting trigger; and
initiate an RLF procedure of the UE based at least in part on detecting the condition indicative of a RLF.
